(19) United States
(12) Patent Application Publication
(10) Pub. No.: US 2026/0133380 A1
(43) Pub. Date: May 14, 2026

(54) SEMICONDUCTOR DEVICES AND METHODS OF FORMATION

(71) Applicant: Taiwan Semiconductor Manufacturing Company, Ltd., Hsinchu (TW)

(72) Inventors: Tzu Jung TIEN, Hsinchu County (TW); Jen-Yuan CHANG, Hsinchu City (TW)

(21) Appl. No.: 18/946,083

(22) Filed: Nov. 13, 2024

(51) Int. Cl. G02B 6/42

(52) U.S. Cl. CPC G02B 6/4206

(57) ABSTRACT

A device package includes a package substrate, and an optical connector package may be included in the package substrate. The optical connector package may include an optical fiber embedded in the optical connector package, and the optical fiber may be oriented to optically couple optical signals to a grating coupler included in an IC die on the package substrate. The optical fiber may be arranged to receive the optical signals from the side of the package substrate, the top of the package substrate, and/or from portion of the package substrate.

### BACKGROUND

A device package (e.g., a semiconductor die package) may include one or more integrated circuit (IC) dies that are bonded to a package substrate. Examples of IC dies include a system-on-chip (SoC) IC die, a dynamic random access memory (DRAM) IC die, a logic IC die, a photonics IC die (e.g., a semiconductor photonics device), and/or a high bandwidth memory (HBM) IC die, among other examples. An interposer may be used to redistribute contact areas from the IC dies to a larger area of the interposer. An interposer may enable three-dimensional (3D) packaging and/or other advanced semiconductor packaging techniques.

A semiconductor package may include one or more semiconductor die packages that are bonded to a package substrate. The semiconductor die packages may be electrically interconnected through one or more redistribution structures of the package substrate. This enables the semiconductor package to include semiconductor die packages that provide different functionality, such as memory, processing, communication, and/or input/output (I/O), among other examples.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example implementation of a device package described herein.

FIGS. 2A-2F are diagrams of an example implementation of forming a device package described herein.

FIGS. 3A and 3B are diagrams of an example implementation of a device package described herein.

FIG. 4 is a diagram of an example implementation of a device package described herein.

FIG. 5 is a diagram of an example implementation of an electronic device described herein.

FIG. 6 is a diagram of an example implementation of an electronic device described herein.

FIG. 7 is a diagram of an example implementation of an electronic device described herein.

FIG. 8 is a diagram of an example implementation of an electronic device described herein.

FIG. 9 is a flowchart of an example process associated with forming a semiconductor device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An integrated circuit (IC) die of a device package may include a grating coupler that is configured to receive optical signals (e.g., a laser signal or incident light) and direct the optical signals toward a photodetector of the semiconductor device. The photodetector may convert the optical signals to electrical signals that may be processed by IC devices (e.g., electronic IC devices) of another IC die included in the device package.

In some cases, interference with reception of an optical signal at a grating coupler of the IC die may occur, for various reasons. For example, the IC die may include a plurality of grating couplers positioned near each other, and optical signals directed to these grating couplers can interfere with each other (referred to as optical crosstalk), which can lead to increased conversion errors when converting the optical signals to electrical signals. The grating couplers may be spaced further apart to reduce the likelihood of optical crosstalk; however, this increases the lateral size of the IC die. As another example, an optical signal may propagate through a plurality of layers of the device package before reaching the grating coupler of the IC die, and the longer the distance traveled through the layers, the greater the amount of scattering of the optical signal that can occur.

In some implementations described herein, a device package includes a package substrate, and an optical connector package may be included in the package substrate. The optical connector package may include an optical fiber embedded in the optical connector package, and the optical fiber may be oriented to optically couple optical signals to a grating coupler included in an IC die on the package substrate. The optical fiber may be arranged to receive the optical signals from the side of the package substrate, the top of the package substrate, and/or another portion of the package substrate.

The optical fiber in the optical connector package defines an optical signal path through which optical signals propagate to the grating coupler. The optical fiber may reduce the likelihood of scattering of the optical signals into the layers of the IC die around the grating coupler, thereby increasing the intensity of optical signals received at the grating coupler. Additionally and/or alternatively, the optical fiber may reduce the likelihood of other optical signals interfering with an optical signal, by reducing scattering and/or diffusion of the other optical signals, thereby reducing optical crosstalk in the IC die. In this way, the optical connector package reduces scattering of and/or interference with the optical signal, which may reduce the likelihood of and/or the rate of conversion errors when converting the optical signal to an electrical signal.

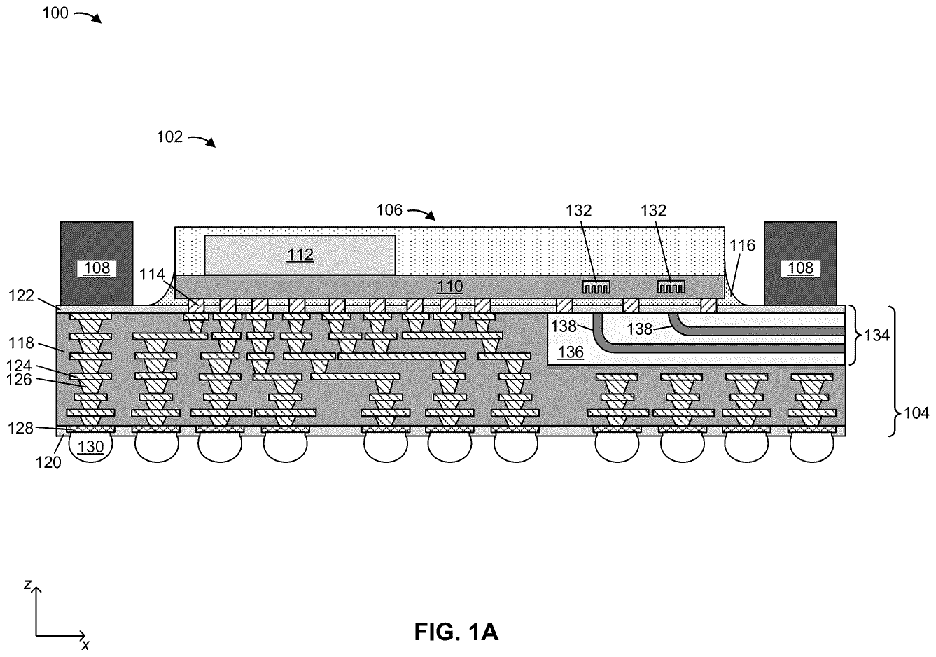

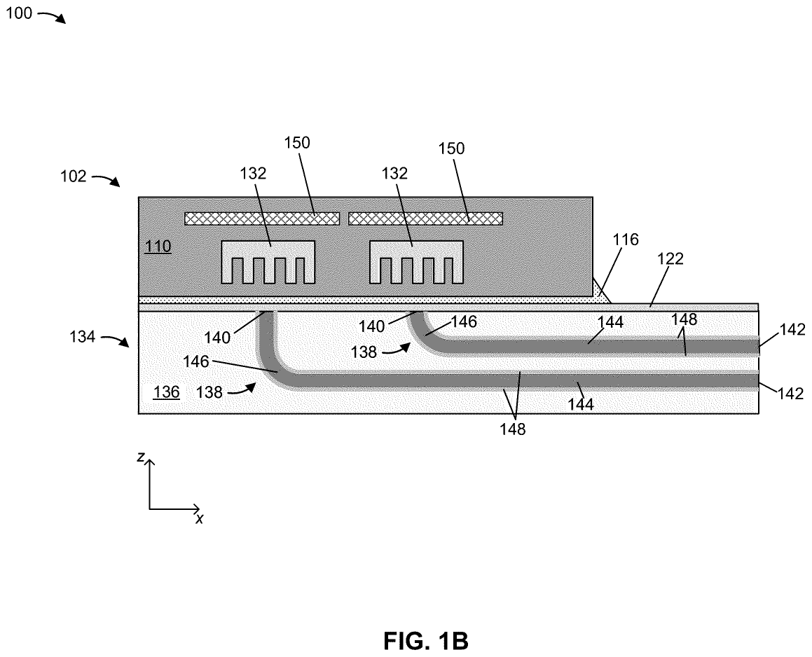

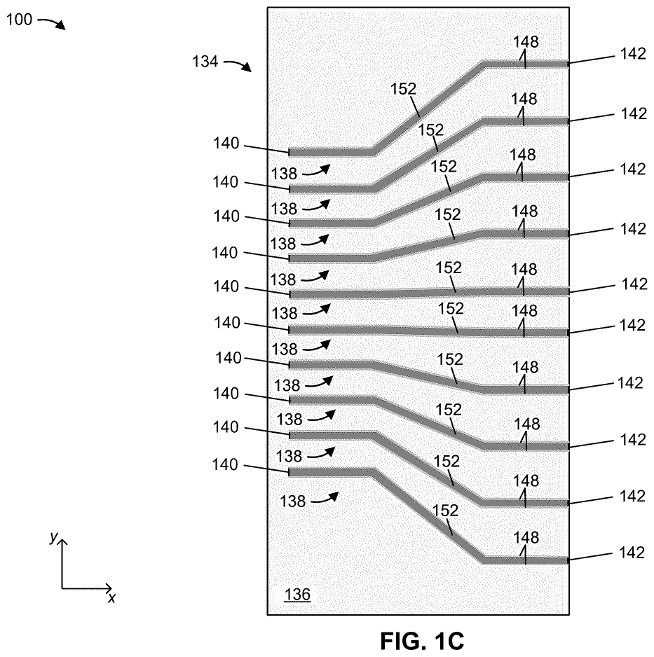

FIGS. 1A-1C are diagrams of an example implementation 100 of a device package 102 described herein. FIG. 1A illustrates a cross-section view in an x-direction in the device package 102. As shown in FIG. 1A, the device package 102 includes a packaged semiconductor device that includes a package substrate 104 and one or more semiconductor die packages 106 bonded, attached, mounted, and/or otherwise secured to the package substrate 104. The device package 102 may be referred to as a 3D package, a 2.5D package, and/or another type of semiconductor package.

As shown in FIG. 1A, a stiffener structure 108 may be included over and/or on the package substrate 104. The semiconductor die package(s) 106 may be positioned within a perimeter of the stiffener structure 108 and may be spaced apart from the stiffener structure 108. The stiffener structure 108 may be included to reduce warpage and bending, and to maintain planarity of the package substrate 104. The stiffener structure 108 may include active circuitry, a non-active structure, or a combination thereof. The stiffener structure 108 may include one or more metal materials, one or more dielectric materials, and/or one or more materials of another type of material.

As further shown in FIG. 1A, a semiconductor die package 106 may include one or more integrated circuit (IC) dies, such as an IC die 110 and an IC die 112 bonded, attached, mounted, and/or otherwise secured to the IC die 110. The IC dies 110 and 112 may be stacked and vertically arranged in the z-direction in the semiconductor die package 106. The quantity and arrangement of IC dies in the semiconductor die package 106 illustrated in FIG. 1A is an example, and other quantities and arrangements are within the scope of the present disclosure. In some implementations, a semiconductor die package 106 may include a single IC die.

The IC die 110 is semiconductor device that includes one or more photonics components such as grating couplers, waveguides, photodiodes, splitters, polarizers, optical modulators, optical resonators, and/or edge couplers, among other examples. The IC die 110 may be configured to receive and/or transmit optical signals, process optical signals, and/or to perform other functions associated with optical signals. In some implementations, the IC die 110 is configured to convert optical signals to electrical signals, and/or to convert electrical signals to optical signals.

The IC die 112 may include active integrated circuits of the semiconductor die package 106 and may be configured perform various processing functions of the semiconductor die package 106. For example, the IC die 112 may be configured to process electrical signals that are converted from optical signals by the IC die 110. As another example, the IC die 112 may generate electrical signals that are to be converted to optical signals by the IC die 110. Examples for the IC die 112 includes a logic IC die, a memory IC die, a high-bandwidth memory (HBM) IC die, an input/output (I/O) die, a system-on-chip (SoC) IC die, a dynamic random access memory (DRAM) IC die, a complementary metal-oxide-semiconductor (CMOS) image sensor IC die, a silicon photonics IC die, a central processing unit (CPU) IC die, a graphics processing unit (GPU) IC die, a digital signal processing (DSP) IC die, an application specific integrated circuit (ASIC) IC die, and/or another type of active IC die.

In some implementations, one or more non-active dies may be included in the semiconductor die package 106. Examples of non-active dies include dummy dies and/or other types of non-active dies. A dummy die may also be referred to as an insertion die, a filler die, and/or another type of die that does not perform electrical and/or processing functions of the semiconductor die package 106. The quantity and/or position of the non-active dies in the top view of the semiconductor die package 106 (e.g., the horizontal arrangement of non-active dies in the top view) may be determined and/or selected to achieve and/or satisfy one or more parameters for semiconductor die package 106. Unused area (e.g., area that is not occupied by at least one IC die) in the horizontal arrangement of IC dies in the semiconductor die package 106 may result in reduced stiffness and/or reduced rigidity for the semiconductor die package 106. This may increase the likelihood of bending, warpage, and/or physical damage to the semiconductor die package 106. Accordingly, the quantity and/or position of the non-active dies may be determined and/or selected to reduce and/or minimize unused area in the horizontal arrangement of the IC dies in the top view. Thus, the non-active dies may be positioned in unused area between two or more active IC dies, may be positioned in unused area adjacent to (or next to) one or more active IC dies, or a combination thereof, to minimize unused area in the horizontal arrangement of IC dies in the top view of the semiconductor die package 106.

The semiconductor die package 106 may be attached to the package substrate 104 of the device package 102 by a plurality of connection structures 114. The connection structures 114 may include a stud, a pillar, a bump, a solder ball, a micro-bump, an under-bump metallization (UBM) structure, and/or another type of connection structure, among other examples. The connection structures 114 may include one or more materials, such as a gold (Au) material, a copper (Cu) material, a silver (Ag) material, a nickel (Ni) material, a tin (Sn) material, a lead (Pb) material, or a palladium (Pd) material, among other examples. In some implementations, the one or more materials may be lead-free (e.g., Pb-free).

An underfill material 116 may be included between the semiconductor die package 106 and between the connection structures 114 of the semiconductor die package 106. The underfill material 116 may include a polymer, one or more fillers dispersed in a resin, an epoxy-based resin, and/or another type of insulating material. The underfill material 116 may extend outward from the semiconductor die package 106 and toward the stiffener structure 108. For example, the underfill material 116 may extend outward in a tapered or sloped manner. As another example, underfill material 116 may extend outward in a concave manner or in a convex manner.

As further shown in FIG. 1A, the package substrate 104 of the device package 102 includes an insulator layer 118 that may be sandwiched between passivation layers 120 and 122 on opposing sides of the package substrate 104 in the z-direction. The passivation layer 120 may be included on the bottom of the package substrate 104, and the passivation layer 122 may be included on the top of the package substrate 104. The passivation layers 120 and 122 may each include a solder resist (SR) mask that enables connection structures to be selectively attached to conductive structures in the package substrate 104. In some implementations, the passivation layers 120 and 122 include one or more polymer materials, one or more dielectric materials (e.g., a silicon oxide (SiOₓ), a silicon nitride (SiₓN_{y}), a silicon carbide (SiCₓ), a silicon carbon nitride (SiCN), and/or a silicon oxynitride (SiON)), and/or another suitable electrically insulating material.

The insulator layer 118 may include polyimide, polybenzoxazole (PBO), benzocyclobutene (BCB), an ajinomoto buildup film (ABF), a solder resist (SR) film, a pre-impregnated composite fiber (prepreg), a non-woven glass fabric, and/or another suitable insulator material. A plurality of conductive structures may be included in the insulator layer 118, and may be arranged in a plurality of vertically stacked layers in the z-direction. The layers of conductive structures may extend between a top side of the package substrate 104 facing the semiconductor die package 106 and a bottom side of the package substrate 104 vertically opposing the top side in the z-direction. The layers of conductive structures may include a plurality of alternating layers of metallization layers 124 and interconnect layers 126. The metallization layers 124 and the interconnect layers 126 are electrically interconnected to provide a signal and/or power distribution path throughout the package substrate 104.

The metallization layers 124 may include a combination of trenches, metallization layers, conductive traces, and/or other types of conductive structures. The interconnect layers 126 may include a combination of vias, interconnects, and/or other types of conductive structures. The metallization layers 124 and the interconnect layers 126 may each include one or more electrically conductive materials such as tungsten (W), cobalt (Co), ruthenium (Ru), titanium (Ti), aluminum (Al), copper (Cu), gold (Au), and/or a combination thereof, among other examples of electrically conductive materials.

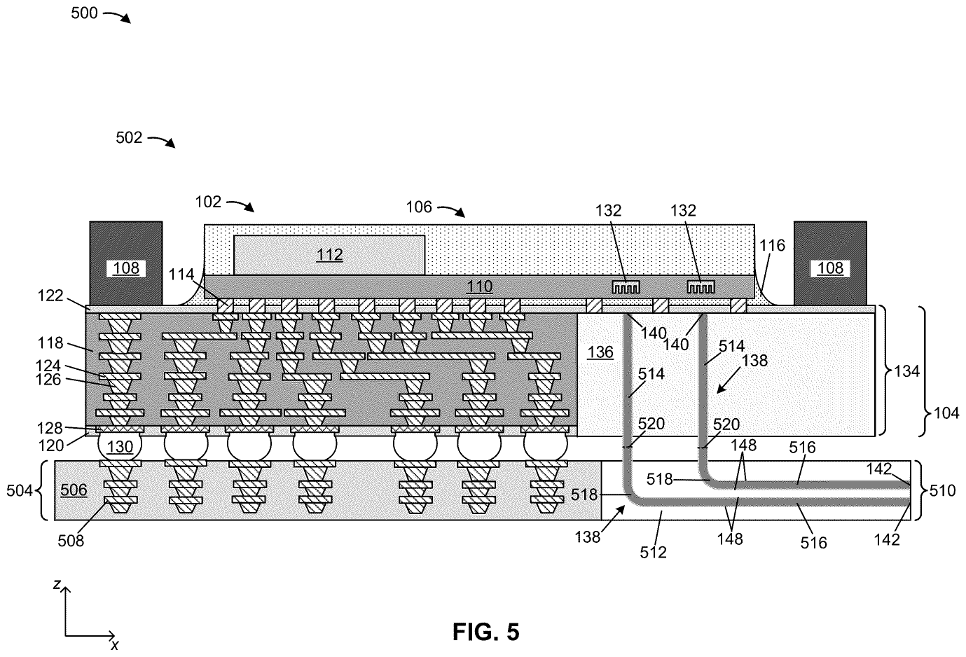

As further shown in FIG. 1A, at the bottom of the package substrate 104, a layer of package connection pads 128 is located in the passivation layer 120 and is electrically coupled to a bottom-most layer of conductive structures (e.g., a bottom-most metallization layer 124, a bottom-most interconnect layer 126) of the package substrate 104. The package connection pads 128 may electrically couple the conductive structures of the package substrate 104 to package connection structures 130 of the device package 102. In some implementations, the package connection pads 128 include a different electrically conductive material (e.g., aluminum (Al), aluminum copper (AlCu) than the electrically conductive material of the bottom conductive pads (e.g., copper (Cu)) to facilitate adherence of the package connection structures 130 to the package connection pads 128. The package connection structures 130 may include solder balls, BGA ball grid array (BGA) balls, land grid array (LGA) pads, pin grid array (PGA) pins, and/or another type of connection structures that enable the device package 102 to be attached (e.g., soldered, bonded, socketed) to another device or layer, such as a device substrate 504 of an electronic device 502 illustrated and described in connection with FIG. 5.

As further shown in FIG. 1A, one or more grating couplers 132 are included in the IC die 110. A grating coupler 132 includes a photonics device that is configured to couple optical signals from an optical fiber to one or more other photonics devices (e.g., waveguides, splitters, polarizers, modulators, demodulators, resonators, photodetectors) included in the IC die 110. A grating coupler 132 may be configured to receive optical signals along a first direction (e.g., a z-direction) and redirect the optical signals along a second direction (e.g., an x-direction, a y-direction).

A grating coupler 132 may include a plurality of gratings. In some implementations, the gratings of a grating coupler 132 may be periodic, and the periodicity of the gratings may be selected to achieve diffraction of one or more wavelengths of optical signals. In some implementations, the periodicity of the gratings of a grating coupler 132 may be selected based on the wavelength(s) that are to be used for optical communication, may be selected based on the wavelength(s) that are to be used for wavelength division multiplexing (WDM), and/or may be selected for another purpose.

In some implementations, a grating coupler 132 is formed of a semiconductor material such as silicon (Si), germanium (Ge), and/or silicon germanium (SiGe), among other examples. In some implementations, a grating coupler 132 is formed of a dielectric material such as silicon nitride (SiₓN_{y} such as Si₃N₄) and/or silicon oxide (SiOₓ such as SiO₂), among other examples. In some implementations, a grating coupler 132 is a hybrid grating coupler structure that includes a dual-layer structure having a dielectric portion and a semiconductor portion.

The grating coupler(s) 132 may be located in a portion or region of the IC die 110 that extends laterally over an optical connector package 134 that is included in the package substrate 104. This provides an unobstructed light propagation path for optical signals to propagate from the optical connector package 134 to the grating coupler(s) 132.

The optical connector package 134 is a structure that is configured to couple optical signals from an external source to the grating coupler(s) 132 with minimal optical loss and minimal optical crosstalk. The optical connector package 134 may include a dielectric structure 136 and one or more optical fibers 138 included in the dielectric structure 136. The dielectric structure 136 may include one or more polymer materials, one or more dielectric materials (e.g., a silicon oxide (SiOₓ), a silicon nitride (SiₓN_{y}), a silicon carbide (SiCₓ), a silicon carbon nitride (SiCN), and/or a silicon oxynitride (SiON)), and/or another suitable electrically insulating material. The optical fibers 138 may include silica (e.g., SiO₂), plastic optical fibers (POFs), polymethyl methacrylate (PMMA), and/or another suitable optical fiber material.

The optical fibers 138 may be oriented such that a first end of an optical fiber 138 is facing an associated grating coupler 132 in the IC die 110, and such that a second opposing end of the optical fiber 138 is facing an outer edge of the package substrate 104, such as a side of the package substrate 104. This enables optical signals to be provided to the optical fiber 138 through the second end, and the optical signals may propagate through the optical fiber 138 from the second end to the first end where the optical signals couple to an associated grating coupler 132 in the IC die 110. The grating coupler(s) 132 may be facing downward (e.g., the gratings of the grating coupler(s) 132 may be facing the optical connector package 134 in the package substrate 104) to facilitate the coupling of optical signals from the optical fibers 138 to the grating coupler(s) 132.

The optical fibers 138 may include various segments, bends, transitions, and/or other components to facilitate distribution of optical fibers 138 within the dielectric structure 136 of the optical connector package 134. Additionally and/or alternatively, the optical fibers 138 may be arranged and/or distributed in one or more directions in the dielectric structure 136 of the optical connector package 134, including in the x-direction (e.g., optical fibers 138 may be laterally arranged in the x-direction), and/or in the y-direction (e.g., optical fibers 138 may be laterally arranged in the y-direction), and/or in the z-direction (e.g., optical fibers 138 may be vertically arranged in the z-direction).

The optical connector package 134 may be included in (e.g., embedded in) the insulator layer 118 of the package substrate 104. Embedding the optical connector package 134 in the package substrate 104 conserves space and enables a reduced size to be achieved for the device package 102 relative to including the optical connector package 134 as a separate structure that is included on or next to the semiconductor die package 106. Additionally and/or alternatively, the optical fibers 138 confine optical signals, which reduces scattering and/or diffusion of the optical signals. This reduces the amount of (and/or the likelihood of) crosstalk between optical signals for adjacent grating couplers 132 in the IC die 110, which enables the grating couplers 132 to be positioned closer together to achieve lower device pitch and greater device density in the IC die 110.

FIG. 1B illustrates a detailed view of the optical connector package 134. As shown in FIG. 1B, the optical fibers 138 may be separated by the dielectric structure 136 to optically isolate the optical fibers 138. An optical fiber 138 may include an end 140 facing a grating coupler 132 in the z-direction (e.g., facing the top of the package substrate 104) and an opposing end 142 facing a side of the package substrate 104. As indicated above, an optical fiber 138 may include various segments, including a segment 144 (e.g., a substantially straight segment), a transition segment 146 (e.g., a bend), and/or another segment.

A segment 144 may provide for propagation of optical signals along a particular direction. For example, a segment 144 of an optical fiber 138 may provide for propagation of optical signals along the x-direction in the device package 102.

A transition segment 146 may provide a transition between a first direction and a second direction to facilitate transition of optical signal propagation from the first direction to the second direction. As an example, a transition segment 146 may provide a transition between optical signal propagation in the x-direction to optical signal propagation in the z-direction.

As further shown in FIG. 1B, a cladding layer 148 may be included on the sidewalls of an optical fiber 138. The cladding layer 148 may surround the optical fiber 138 and may be included to further increase optical confinement within the optical fiber 138. This reduces the likelihood of optical leakage from the optical fiber 138 and/or reduces the likelihood of optical crosstalk between the optical fiber 138 and another optical fiber 138.

A cladding layer 148 may include one or more materials that promote internal reflection of optical signals in an associated optical fiber 138, and that inhibit diffraction of optical signals through the cladding layer 148. For example, a cladding layer 148 may be formed of a dielectric material having a lower refractive index than the refractive index of the material of an associated optical fiber 138. The lower refractive index of the cladding layer 148 causes light to be confined within the optical fiber 138 due to total internal reflection of optical signals at the interface between the optical fiber 138 and the cladding layer 148. Examples of such low refractive index materials include various fluoropolymers such as poly(hexafluoropropylene oxide) and/or poly(pentadecafluorooctyl acrylate), and/or non-fluorinated polymers such as poly(methyl hydro siloxane) and/or hydroxypropyl cellulose, among other examples.

As further shown in FIG. 1B, in some implementations, reflection structures 150 may be included in the IC die 110 above the grating couplers 132. The reflection structures 150 may be formed of reflective materials such as one or more metals and may be included to inhibit optical signals from propagating through the IC die 110.

FIG. 1C illustrates a top view of the optical connector package 134 and illustrates an example top view layout of optical fibers 138 in the optical connector package 134. As shown in FIG. 1C, the optical fibers 138 may be arranged or distributed in the y-direction, and may extend primarily in the x-direction. The ends 142 of the optical fibers 138 may be facing a side of the dielectric structure 136 in the x-direction. However, other arrangements are within the scope of the present disclosure.

As further shown in FIG. 1C, the optical fibers 138 may be fanned out in the y-direction to provide increased spacing between the ends 142, compared to the spacing between the ends 140, to facilitate coupling of optical signals from external connectors to the ends 142 with minimal optical crosstalk. Fanout of the optical fibers 138 in the y-direction may be achieved through the inclusion of offset segments 152 between the ends 140 and 142 of the optical fibers 138. An offset segment 152 may be angled relative to the x-direction such that the offset segment 152 is not parallel to the x-direction. The offset segments 152 of two or more optical fibers 138 may be angled differently relative to the x-direction. Additionally and/or alternatively, the offset segments 152 of two or more optical fibers 138 may be angled approximately the same, relative to the x-direction.

As indicated above, FIGS. 1A-1C are provided as an example. Other examples may differ from what is described with regard to FIGS. 1A-1C.

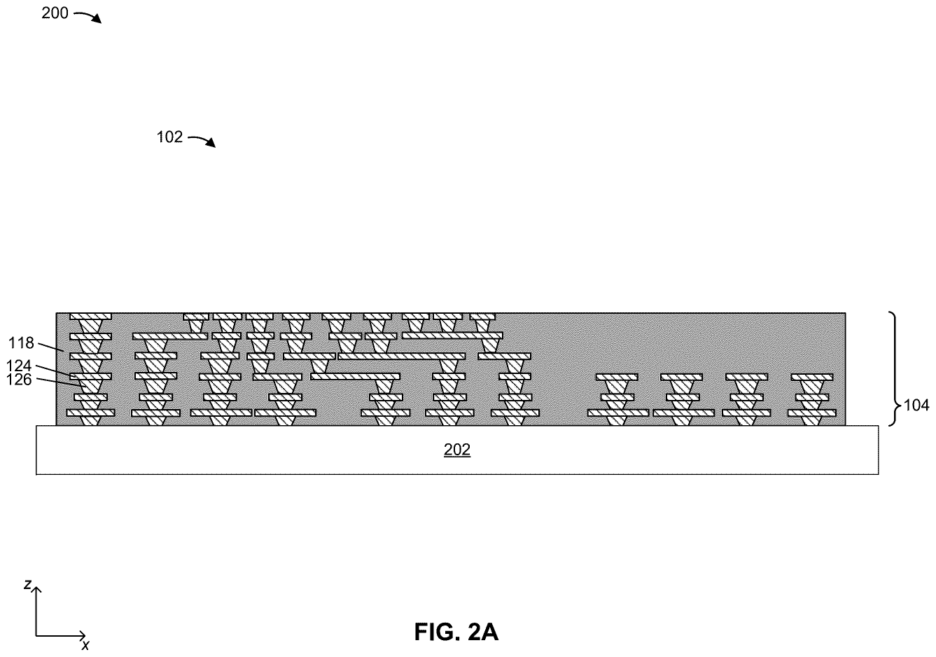

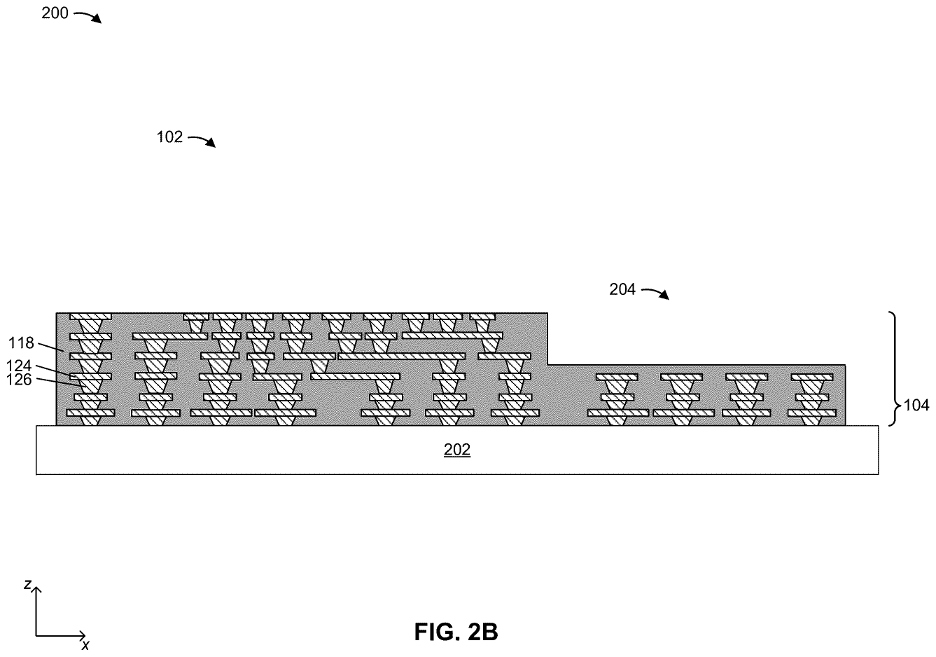

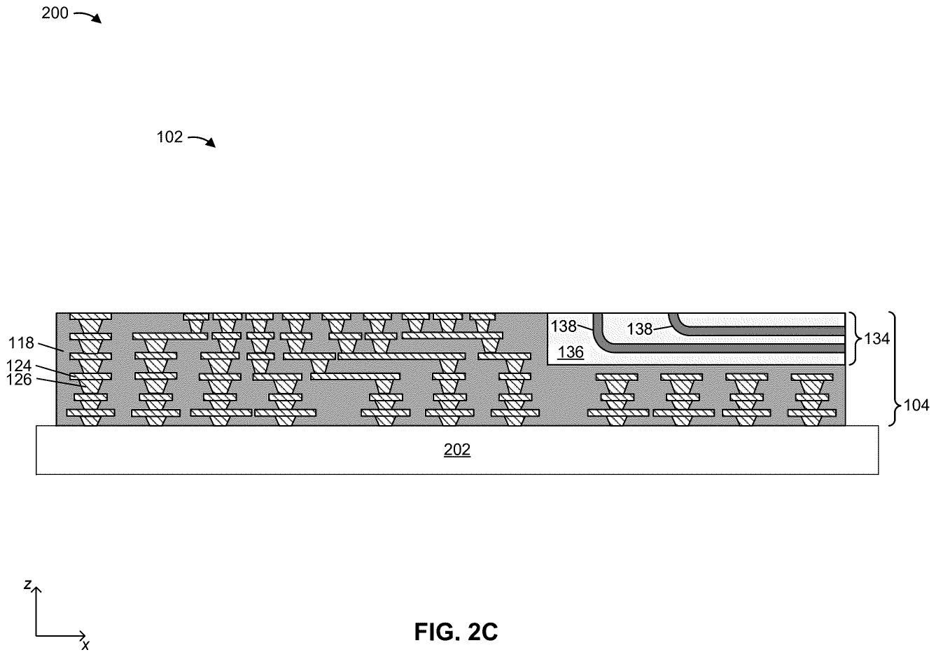

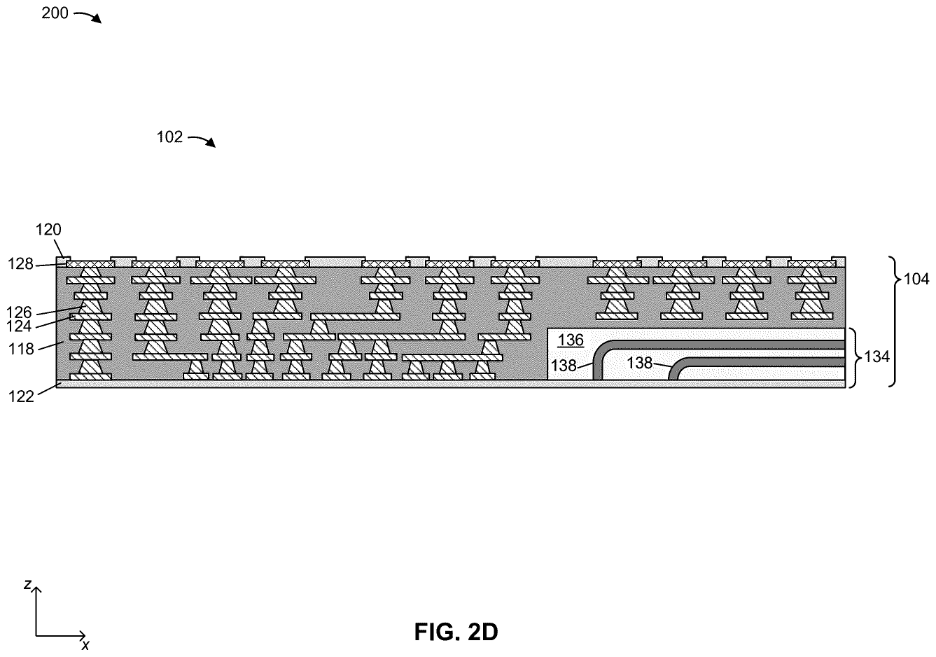

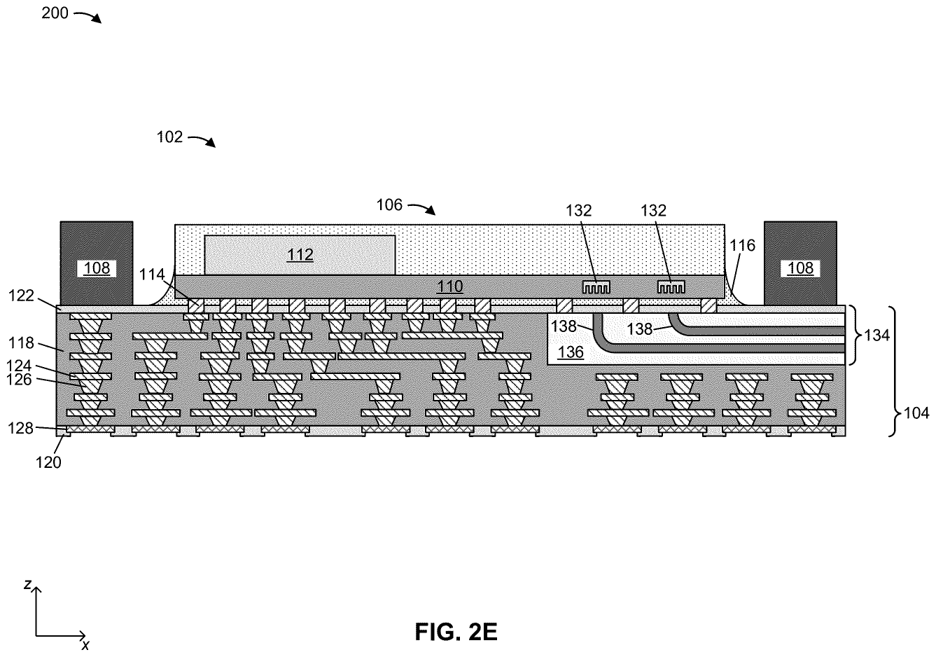

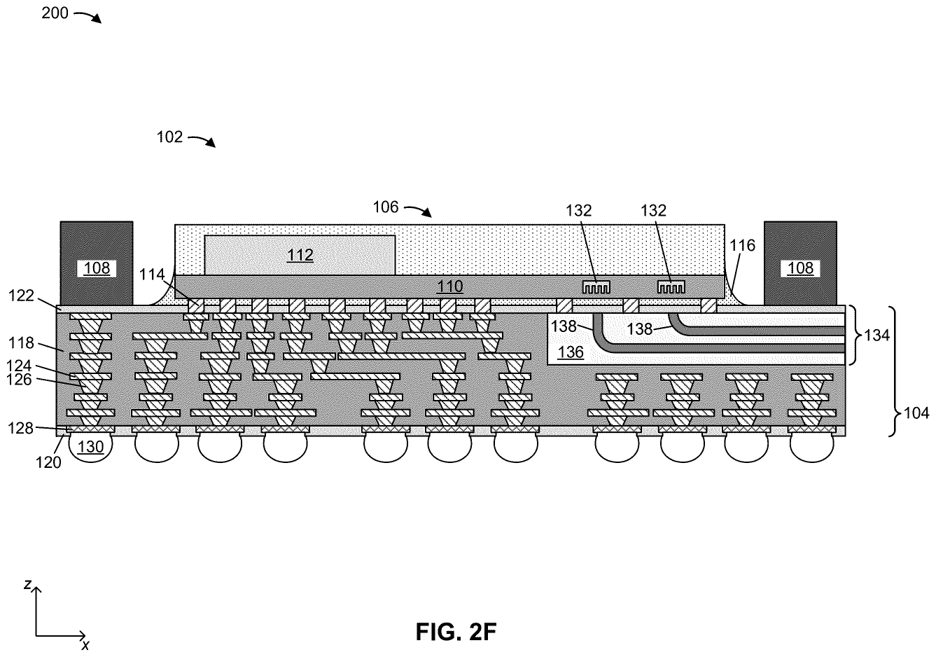

FIGS. 2A-2F are diagrams of an example implementation 200 of forming the device package 102 described herein. One or more of semiconductor processing tools may be used to perform one or more of the operations described in connection with FIGS. 2A-2F, such as a deposition tool, an exposure tool (e.g., a photolithography tool), a developer tool, an etch tool, a planarization tool (e.g., a chemical-mechanical planarization (CMP) tool, a wafer grinding tool), a pick-and-place tool, a soldering tool, a bonding tool, and/or another semiconductor processing tool.

As shown in FIG. 2A, the package substrate 104 of the device package 102 may be formed on a carrier substrate 202. The carrier substrate 202 may facilitate building up the package substrate 104 layer by layer so that a plurality of vertically-arranged layers of conductive structures (e.g., metallization layers 124, interconnect layers 126) may be formed.

Forming the package substrate 104 may include forming a first portion of the insulator layer 118 of the package substrate 104 on the carrier substrate 202, forming recesses in the first portion of the insulator layer 118, and forming a first layer of conductive structures (e.g., a first metallization layer 124, a first interconnect layer 126) of the package substrate 104 in the recesses. A second portion of the insulator layer 118 may be formed on the first portion, recesses may be formed in the second portion of the insulator layer 118, and a second layer of conductive structures (e.g., a second metallization layer 124, a second interconnect layer 126) may be formed in the second portion of the insulator layer 118 such that the second layer of conductive structures is electrically coupled and/or physically coupled to the first layer of conductive structures. Additional layers of conductive structures of the package substrate 104 may be formed in a similar manner. Additionally and/or alternatively, a layer of conductive structures may be formed first, and a portion of the insulator layer 118 may be formed around the layer of conductive structures.

A deposition tool may be used to deposit the insulator layer 118 using a chemical vapor deposition (CVD) technique, a physical vapor deposition (PVD) technique, an atomic layer deposition (ALD) technique, and/or another suitable deposition technique. Additionally and/or alternatively, material of the insulator layer 118 may be dispensed onto the carrier substrate 202 and cured.

In some implementations, a pattern in a photoresist layer is used to etch the insulator layer 118 to form the recesses. In these implementations, a deposition tool may be used to form the photoresist layer on the insulator layer 118 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the insulator layer 118 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the insulator layer 118 based on a pattern.

A deposition tool may be used to deposit the layers of conductive structures (e.g., the metallization layers 124 and/or the interconnect layers 126) using a CVD technique, a PVD technique, an ALD technique, an electroplating technique, and/or another suitable deposition technique. The layers of conductive structures may be deposited in one or more deposition operations. In some implementations, a seed layer is first deposited, and a layer of conductive structures are deposited on the seed layer. In some implementations, a liner is first deposited in the recesses, and a layer of conductive structures are deposited on the liner. The liner may include a barrier liner, an adhesion liner, and/or another type of liner. Examples of liner materials may include tantalum nitride (TaN), titanium nitride (TiN), and/or another suitable liner material. In some implementations, a planarization tool is used to perform a planarization operation (e.g., a CMP operation) to planarize the layers of conductive structures after the layers of conductive structures are deposited.

As shown in FIG. 2B, a recess 204 may be formed in a front side of the package substrate 104. The recess 204 may be formed in the insulator layer 118. In some implementations, a pattern in a photoresist layer is used to etch the insulator layer 118 to form the recess 204. In these implementations, a deposition tool may be used to form the photoresist layer on the insulator layer 118 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the insulator layer 118 based on the pattern to form the recess 204. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the insulator layer 118 based on a pattern.

As shown in FIG. 2C, an optical connector package 134 may be provided in the recess 204. In some implementations, a pick-and-place tool is used to place the optical connector package 134 in the recess 204. In some implementations, a bonding tool is used to bond the dielectric structure 136 of the optical connector package 134 to the insulator layer 118.

In some implementations, the optical connector package 134 is provided in the recess 204 as a pre-manufactured component. In some implementations, the optical connector package 134 may be formed in the recess 204. Forming the optical connector package 134 may include providing the optical fibers 138, and forming the dielectric structure 136 around the optical fibers 138. In some implementations, the optical fibers 138 may be placed in a mold, and the material of the dielectric structure 136 may be deposited around the optical fibers 138. In some implementations, a first portion of the dielectric structure 136 is formed, the optical fibers 138 are placed on the first portion of the dielectric structure 136, and a second portion of the dielectric structure 136 is deposited over the optical fibers 138 such that the optical fibers 138 are encapsulated in the dielectric structure 136.

As shown in FIG. 2D, a layer of package connection pads 128 of the package substrate 104 may be formed on the back side of the package substrate 104. A deposition tool may be used to deposit the layer of package connection pads 128 using a CVD technique, a PVD technique, an ALD technique, an electroplating technique, and/or another suitable deposition technique. The layer of package connection pads 128 may be deposited in one or more deposition operations. In some implementations, a seed layer is first deposited, and the layer of package connection pads 128 are deposited on the seed layer. In some implementations, a liner is first deposited in the recesses, and the layer of package connection pads 128 are deposited on the liner. The liner may include a barrier liner, an adhesion liner, and/or another type of liner. Examples of liner materials may include tantalum nitride (TaN), titanium nitride (TiN), and/or another suitable liner material. In some implementations, a planarization tool is used to perform a planarization operation (e.g., a CMP operation) to planarize the package connection pads 128.

As further shown in FIG. 2D, passivation layers 120 and 122 may be formed over opposing sides of the package substrate 104. A deposition tool may be used to deposit the passivation layers 120 and 122 using a CVD technique, a PVD technique, an ALD technique, and/or another suitable deposition technique. In some implementations, a planarization tool may be used to perform a planarization operation (e.g., a CMP operation) to planarize the passivation layers 120 and 122.

In some implementations, the package connection pads 128 are formed first, and the passivation layer 120 is formed around the package connection pads 128. In some implementations, the passivation layer 120 is formed first, and the package connection pads 128 are formed in the passivation layer 120. In these implementations, openings through the passivation layer 120 may be formed by forming sacrificial structures, forming the passivation layer 120 around the sacrificial structures, subsequently removing the sacrificial structures, and forming the package connection pads 128 in the openings in the passivation layer 120 left behind by the sacrificial structures.

As shown in FIG. 2E, a pick-and-place tool may be used to place one or more semiconductor die packages 106 on the package substrate 104 of the device package 102. For example, the one or more semiconductor die packages 106 may be placed on a metallization layer 124 of the package substrate 104, and a solder tool may be used to perform a solder operation (e.g., wave solder operation, a reflow solder operation) to attach the one or more semiconductor die packages 106 to the package substrate 104. As another example, a bonding tool may be used to perform a bonding operation to bond the connection structures 114 of the one or more semiconductor die packages 106 to a metallization layer 124 of the package substrate 104.

A semiconductor die package 106 may be positioned on the package substrate 104 such that one or more grating couplers 132 of an IC die 110 of the semiconductor die package 106 are positioned over (and aligned with) the ends 140 of one or more optical fibers 138 included in the optical connector package 134 in the package substrate 104. The under fill material 116 may be dispensed around the connection structures 114 of the semiconductor die package 106 to encapsulate the connection structures 114.

As further shown in FIG. 2E, the stiffener structure 108 may be placed on the package substrate 104. The stiffener structure 108 may be positioned such that the semiconductor die package 106 is located within the perimeter of the stiffener structure 108. The stiffener structure 108 may be attached to the package substrate 104 using an epoxy, an adhesive, and/or may otherwise be secured to the package substrate 104.

As shown in FIG. 2F, package connection structures 130 may be attached to the package connection pads 128 at the bottom of the package substrate 104 of the device package 102. For example, solder balls or UBM structures may be attached to the package connection pads 128 on the back side of the package substrate 104. The package connection structures 130 may be attached to the bottom of the package substrate 104 using the passivation layer 120 as a solder mask.

As indicated above, FIGS. 2A-2F are provided as an example. Other examples may differ from what is described with regard to FIGS. 2A-2F.

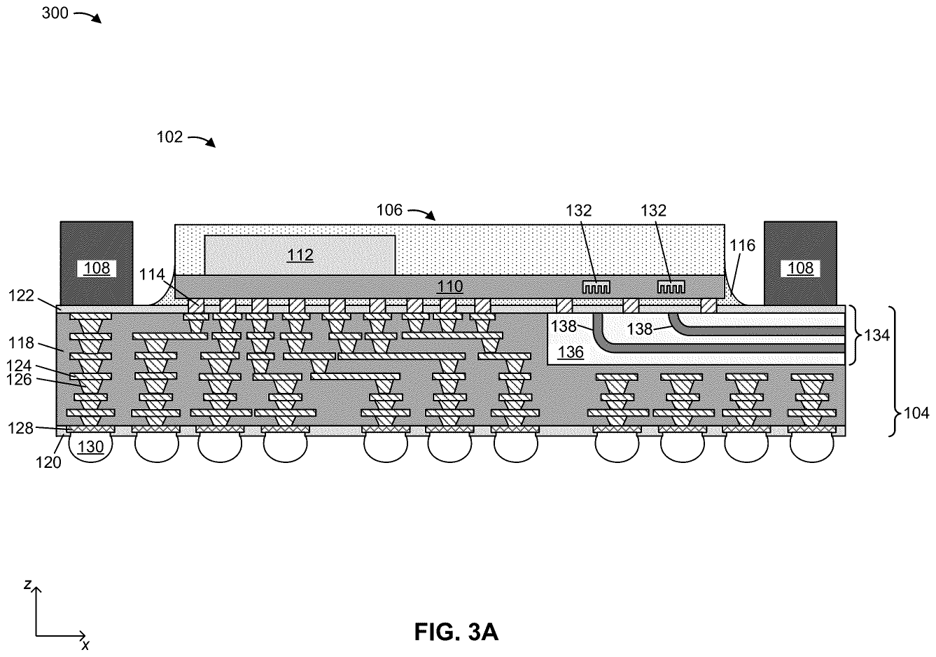

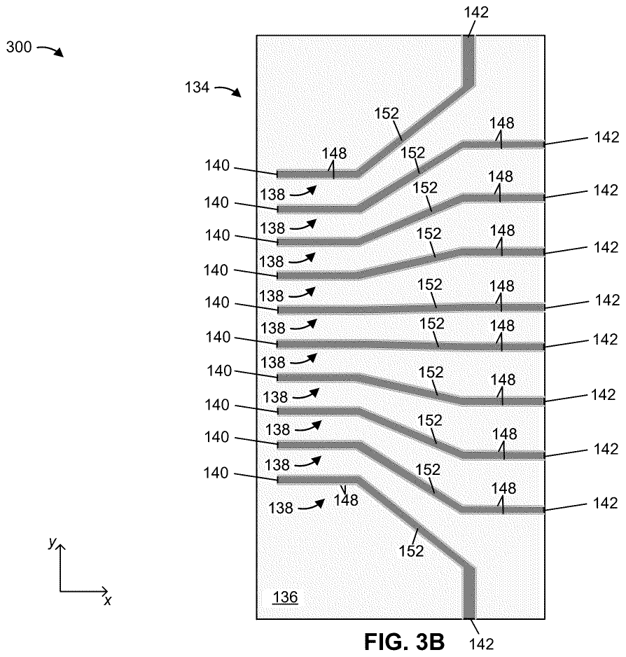

FIGS. 3A and 3B are diagrams of an example implementation 300 of the device package 102 described herein. As shown in FIGS. 3A and 3B, the example implementation 300 of the device package 102 illustrated in FIGS. 3A and 3B is similar to the example implementation 100 of the device package 102 illustrated in FIGS. 1A-1C.

However, as shown in FIG. 3B, in the example implementation 300 of the device package 102, the ends 142 (e.g., the outer ends) of one or more first optical fibers 138 in the optical connector package 134 and the ends 142 of one or more second optical fibers 138 in the optical connector package 134 are facing different directions, and therefore different sides of the optical connector package 134. This provides for greater flexibility in coupling optical signals to the ends 142 of the optical fibers 138, and enables the ends 142 of the optical fibers 138 to be further spread out to reduce optical crosstalk.

For example, the ends 142 of one or more first optical fibers 138 in the optical connector package 134 may be facing a first side of the optical connector package 134 in the y-direction, and the ends 142 of one or more second optical fibers 138 may be facing a second side of the optical connector package 134 in the x-direction. Thus, the ends 142 of the one or more first optical fibers 138 and the ends 142 of the one or more second optical fibers 138 are facing adjacent and perpendicular sides of the optical connector package 134.

As another example, the ends 142 of one or more first optical fibers 138 in the optical connector package 134 may be facing a first side of the optical connector package 134 in the y-direction, and the ends 142 of one or more second optical fibers 138 may be facing a second side of the optical connector package 134 in the y-direction. Thus, the ends 142 of the one or more first optical fibers 138 and the ends 142 of the one or more second optical fibers 138 are facing opposing and parallel sides of the optical connector package 134.

In some implementations, the ends 142 (e.g., the outer ends) of one or more first optical fibers 138 in the optical connector package 134, the ends 142 of one or more second optical fibers 138 in the optical connector package 134, and the ends 142 of one or more third optical fibers 138 in the optical connector package 134 are facing different directions, and therefore different sides of the optical connector package 134.

For example, the ends 142 of one or more first optical fibers 138 in the optical connector package 134 may be facing a first side of the optical connector package 134 in the y-direction, the ends 142 of one or more second optical fibers 138 may be facing a second side of the optical connector package 134 in the x-direction, and the ends 142 of one or more third optical fibers 138 in the optical connector package 134 may be facing a third third of the optical connector package 134 in the y-direction. Thus, the ends 142 of the one or more first optical fibers 138 and the ends 142 of the one or more second optical fibers 138 are facing adjacent and perpendicular sides of the optical connector package 134, the ends 142 of the one or more second optical fibers 138 and the ends 142 of the one or more third optical fibers 138 are facing adjacent and perpendicular sides of the optical connector package 134, and the ends 142 of the one or more first optical fibers 138 and the ends 142 of the one or more third optical fibers 138 are facing adjacent and perpendicular sides of the optical connector package 134.

While the example implementations 100 and 300 include examples of lateral orientation and distribution for the ends 142 of the optical fibers 138 in the optical connector package 134, other examples of lateral orientations and distributions for the ends 142 of the optical fibers 138 in the optical connector package 134 are within the scope of the present disclosure. Additionally and/or alternatively, the example implementations 100 and 300 of lateral orientation and distribution (as well as other examples of lateral orientations and distributions) for the ends 142 of the optical fibers 138 may be implemented in another optical connector package described herein, such as an optical connector package 510 illustrated and described in connection with FIG. 5.

As indicated above, FIGS. 3A and 3B are provided as an example. Other examples may differ from what is described with regard to FIGS. 3A and 3B.

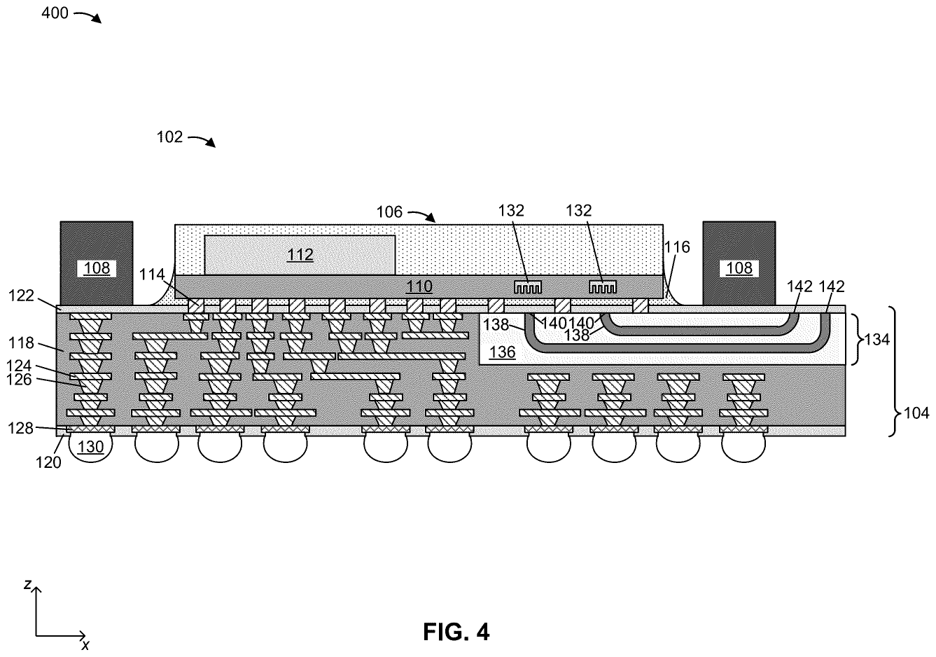

FIG. 4 is a diagram of an example implementation 400 of the device package 102 described herein. As shown in FIG. 4, the example implementation 400 of the device package 102 illustrated in FIG. 4 is similar to the example implementation 100 of the device package 102 illustrated in FIGS. 1A-1C. However, in the example implementation 400 of the device package 102, the ends 142 (e.g., the outer ends) of the optical fibers 138 in the optical connector package 134 are facing the top of the package substrate 104. Thus, the ends 140 (e.g., the inner ends 140) and the ends 142 are facing approximately a same direction and are oriented in the same direction (e.g., in the z-direction). This enables optical signals to be coupled to the optical fibers 138 at the top of the device package 102 as opposed to (or in addition to) being coupled to the optical fibers 138 at a side of the package substrate 104.

In some implementations, the optical fibers 138 extend under the stiffener structure 108, such as in the example illustrated in FIG. 4. In these implementations, the ends 140 of the optical fibers 138 are located within the perimeter of the stiffener structure 108, and the ends 142 of the optical fibers 138 are located outside the perimeter of the stiffener structure 108.

In some implementations, the ends 140 and the ends 142 may be located within the perimeter of the stiffener structure 108 such that the entirety of the optical fibers 138 are located within the perimeter of the stiffener structure 108.

In some implementations, the ends 140 and 142 of a first optical fiber 138 are located within the perimeter of the stiffener structure 108, and the end 140 of a second optical fiber 138 is located within the perimeter of the stiffener structure 108 and the end 142 of the second optical fiber 138 is located outside the perimeter of the stiffener structure 108.

As indicated above, FIG. 4 is provided as an example. Other examples may differ from what is described with regard to FIG. 4.

FIG. 5 is a diagram of an example implementation 500 of an electronic device 502 described herein. As shown in FIG. 5, the electronic device 502 is a semiconductor device that includes a device package 102 that is included on (e.g., bonded to, attached to, soldered to) a device substrate 504. The device substrate 504 may include a circuit board, a printed circuit board (PCB), a socket (e.g., a PGA socket, an LGA socket), and/or another type of substrate that includes an insulator structure 506 and one or more layers of conductive structures 508 included in the insulator structure 506. The connection structures 130 of the device package 102 may be electrically coupled and/or physically coupled to the conductive structures 508 of the device substrate 504.

The device package 102 illustrated in FIG. 5 is similar to the example implementation 100 of the device package 102 illustrated in FIGS. 1A-1C. However, in the example implementation 500 of the electronic device 502, the optical fibers 138 extend through the dielectric structure 136 in the z-direction and through a bottom of the package substrate 104. Moreover, the optical fibers 138 extend into the device substrate 504 and therefore span across the package substrate 104 and the device substrate 504.

As shown in FIG. 5, the device substrate 504 also includes another optical connector package 510. The optical connector package 510 may be positioned under the optical connector package 134 such that the optical connector packages 134 and 510 are vertically adjacent (e.g., in the z-direction) in the electronic device 502. The optical connector package 510 may include a dielectric structure 512 and another portion of the optical fibers 138 in the dielectric structure 512. The cladding layer 148 may be included around the portion of the optical fibers 138 in the dielectric structure 512.

The dielectric structure 512 may include one or more polymer materials, one or more dielectric materials (e.g., a silicon oxide (SiOₓ), a silicon nitride (SiₓN_{y}), a silicon carbide (SiCₓ), a silicon carbon nitride (SiCN), and/or a silicon oxynitride (SiON)), polyimide, polybenzoxazole (PBO), benzocyclobutene (BCB), an ajinomoto buildup film (ABF), a solder resist (SR) film, a pre-impregnated composite fiber (prepreg), a non-woven glass fabric, and/or another suitable insulator material.

As shown in FIG. 5, the ends 140 of the optical fibers 138 are included in the optical connector package 134 and are facing the grating couplers 132 in the IC die 110. Segments 514 of the optical fibers 138 extend through the dielectric structure 136. For example, the segments 514 may extend in the z-direction between the top of the package substrate 104 and the bottom of the package substrate 104. In some implementations, the segments 514 may extend in another direction in the dielectric structure 136.

As further shown in FIG. 5, the ends 142 of the optical fibers 138 are included in the optical connector package 510 and are facing a side of the device substrate 504. Additionally and/or alternatively, one or more of the ends 142 may be facing a bottom of the device substrate 504 and/or one or more of the ends 142 may be facing a top of the device substrate 504. Segments 516 of the optical fibers 138 extend through the dielectric structure 512 of the optical connector package 510. For example, the segments 516 may extend in the x-direction in the dielectric structure 512 of the optical connector package 510. In some implementations, the segments 516 may extend in another direction in the dielectric structure 136.

As further shown in FIG. 5, the optical fibers 138 may include transition segments 518 that transition between the direction in which the segments 516 extend and the direction in which the segments 514 extend. Interfaces 520 between the transition segments 518 and the segments 514 may be located between the package substrate 104 and the device substrate 504. Additionally and/or alternatively, the interface 520 between a transition segment 518 and a segment 514 may be located in the optical connector package 134. Additionally and/or alternatively, the interface 520 between a transition segment 518 and a segment 514 may be located in the optical connector package 510. An interface 520 may include an optical fiber splice, such as a fusion splice (e.g., an interface where the transition segment 518 and the segment 514 are fused together), a mechanical splice (e.g., an interface where the ends of the transition segment 518 and the segment 514 are held together by a sleeve or connector), and/or another type of optical fiber splice.

In some implementations, the device substrate 504 may be formed using similar processing techniques as those described in connection with FIGS. 2A-2F for the package substrate 104. In some implementations, the optical connector package 510 is formed using similar processing techniques as described in connection with FIGS. 2A-2F for the optical connector package 134. In some implementations, the optical connector package 510 is provided in and/or on the device substrate 504 using similar processing techniques as described in connection with FIGS. 2A-2F for the optical connector package 134.

In some implementations, the electronic device 502 may be formed by providing the device package 102 on the device substrate 504. In some implementations, the connection structures 130 of the device package 102 may be soldered to the conductive structures 508 in the electronic device 502. In some implementations, the connection structures 130 of the device package 102 may be bonded to the conductive structures 508 in the electronic device 502.

As indicated above, FIG. 5 is provided as an example. Other examples may differ from what is described with regard to FIG. 5.

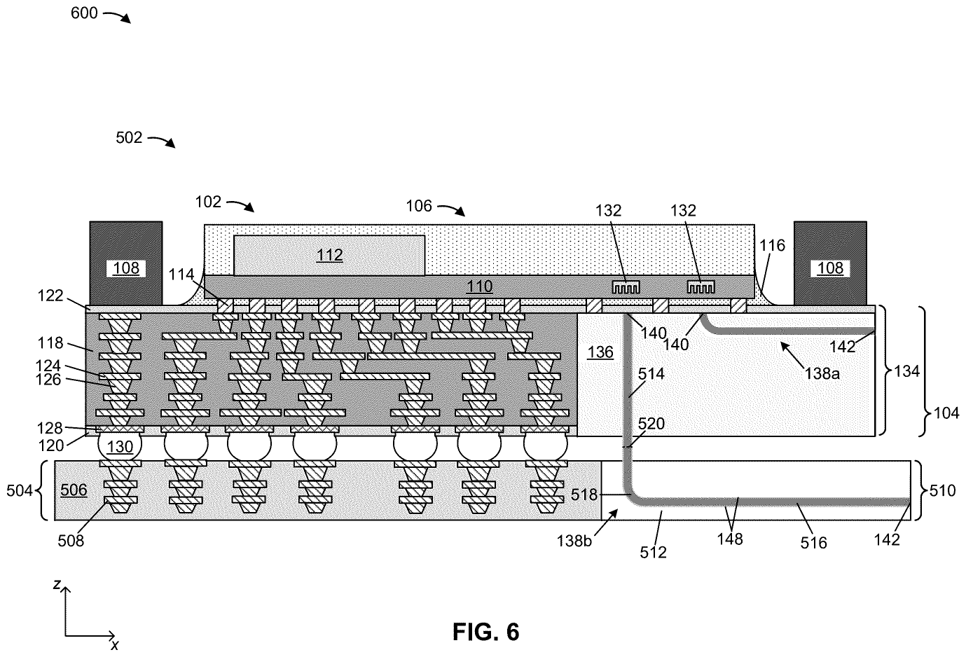

FIG. 6 is a diagram of an example implementation 600 of an electronic device 502 described herein. As shown in FIG. 6, example implementation 600 of the electronic device 502 illustrated in FIG. 6 is similar to the example implementation 500 of the electronic device 502 illustrated in FIG. 5.

However, in the example implementation 600 of the electronic device 502, one or more optical fibers 138a are fully contained within the optical connector package 134, and one or more optical fibers 138b span across the optical connector package 134 and the optical connector package 510. In other words, an optical fiber 138a is included in and extends through only the optical connector package 134, whereas an optical fiber 138b is included in and extends through the optical connector package 134 and the optical connector package 510. This provides for greater flexibility in coupling optical signals to the ends 142 of the optical fibers 138a and 138b, and enables the ends 142 of the optical fibers 138a and 138b to be further spread out to reduce optical crosstalk.

The ends 140 and 142 of the optical fiber(s) 138a are located in the optical connector package 134. The ends 140 are facing the top of the package substrate 104 and are facing one or more grating couplers 132 in the z-direction. The ends 142 are facing a lateral direction (e.g., an x-direction, a y-direction) and are facing a side of the package substrate 104.

The ends 140 of the optical fiber(s) 138b are located in the optical connector package 134, whereas the ends 142 of the optical fiber(s) 138b are located in the optical connector package 510. The ends 140 are facing the top of the package substrate 104 and are facing one or more grating couplers 132 in the z-direction. The ends 142 are facing a lateral direction (e.g., an x-direction, a y-direction) and are facing a side of the package substrate 104. The optical fiber(s) 138b each include a segment 514 in the optical connector package 134, a segment 516 in the optical connector package 510, a transition segment 518 in the optical connector package 510, an interface 520 between the segment 514 and the transition segment 518.

As indicated above, FIG. 6 is provided as an example. Other examples may differ from what is described with regard to FIG. 6.

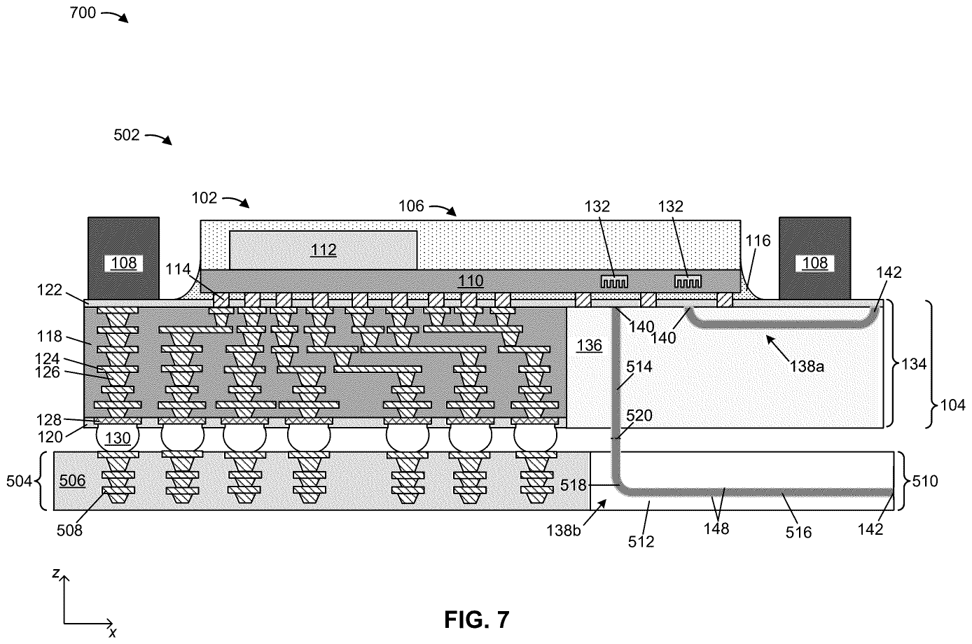

FIG. 7 is a diagram of an example implementation 700 of the electronic device 502 described herein. As shown in FIG. 7, example implementation 700 of the electronic device 502 illustrated in FIG. 7 is similar to the example implementation 600 of the electronic device 502 illustrated in FIG. 6. However, in the example implementation 700 of the electronic device 502, the ends 142 (e.g., the outer ends) of one or more optical fibers 138a contained within the optical connector package 134 are facing the top of the package substrate 104. Thus, the ends 140 (e.g., the inner ends 140) and the ends 142 of the optical fibers 138a are facing approximately a same direction and are oriented in the same direction (e.g., in the z-direction). This enables optical signals to be coupled to the optical fibers 138a at the top of the package substrate 104, as opposed to (or in addition to) being coupled to the optical fibers 138a at a side of the package substrate 104.

In some implementations, the optical fibers 138a extend under the stiffener structure 108, such as in the example illustrated in FIG. 7. In these implementations, the ends 140 of the optical fibers 138a are located within the perimeter of the stiffener structure 108 and the ends 142 of the optical fibers 138a are located outside the perimeter of the stiffener structure 108.

In some implementations, the ends 140 and the ends 142 may be located within the perimeter of the stiffener structure 108 such that the entirety of the optical fibers 138a are located within the perimeter of the stiffener structure 108.

In some implementations, the ends 140 and 142 of a first optical fiber 138a are located within the perimeter of the stiffener structure 108, and the end 140 of a second optical fiber 138a is located within the perimeter of the stiffener structure 108 and the end 142 of the second optical fiber 138a is located outside the perimeter of the stiffener structure 108.

As indicated above, FIG. 7 is provided as an example. Other examples may differ from what is described with regard to FIG. 7.

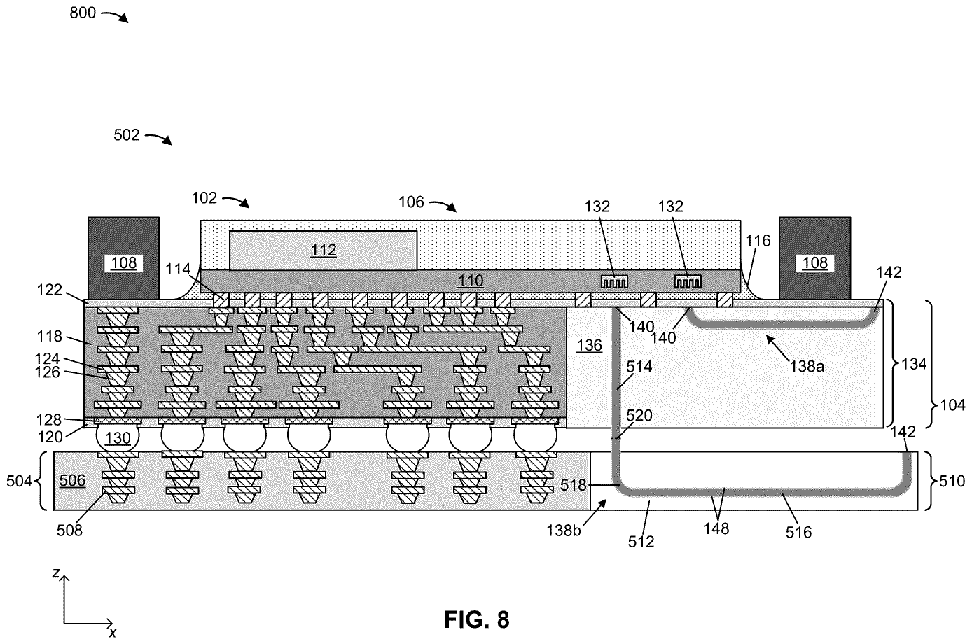

FIG. 8 is a diagram of an example implementation 800 of the electronic device 502 described herein. As shown in FIG. 8, example implementation 800 of the electronic device 502 illustrated in FIG. 8 is similar to the example implementation 600 of the electronic device 502 illustrated in FIG. 6. However, in the example implementation 800 of the electronic device 502, the ends 142 (e.g., the outer ends) of the segments 516 of one or more optical fibers 138b in the optical connector package 134 are facing the top of the device substrate 504. Thus, the ends 140 (e.g., the inner ends 140) and the ends 142 of the optical fibers 138b are facing approximately a same direction and are oriented in the same direction (e.g., in the z-direction). This enables optical signals to be coupled to the optical fibers 138b at the top of the device substrate 504 as opposed to (or in addition to) being coupled to the optical fibers 138b at a side of the device substrate 504.

In some implementations, the optical fibers 138b extend under the stiffener structure 108, such as in the example illustrated in FIG. 8. In these implementations, the ends 140 of the optical fibers 138b are located within the perimeter of the stiffener structure 108 and the ends 142 of the optical fibers 138b are located outside the perimeter of the stiffener structure 108.

In some implementations, the ends 140 and the ends 142 may be located within the perimeter of the stiffener structure 108 such that the entirety of the optical fibers 138b are located within the perimeter of the stiffener structure 108.

In some implementations, the ends 140 and 142 of a first optical fiber 138b are located within the perimeter of the stiffener structure 108, and the end 140 of a second optical fiber 138b is located within the perimeter of the stiffener structure 108 and the end 142 of the second optical fiber 138b is located outside the perimeter of the stiffener structure 108.

As indicated above, FIG. 8 is provided as an example. Other examples may differ from what is described with regard to FIG. 8.

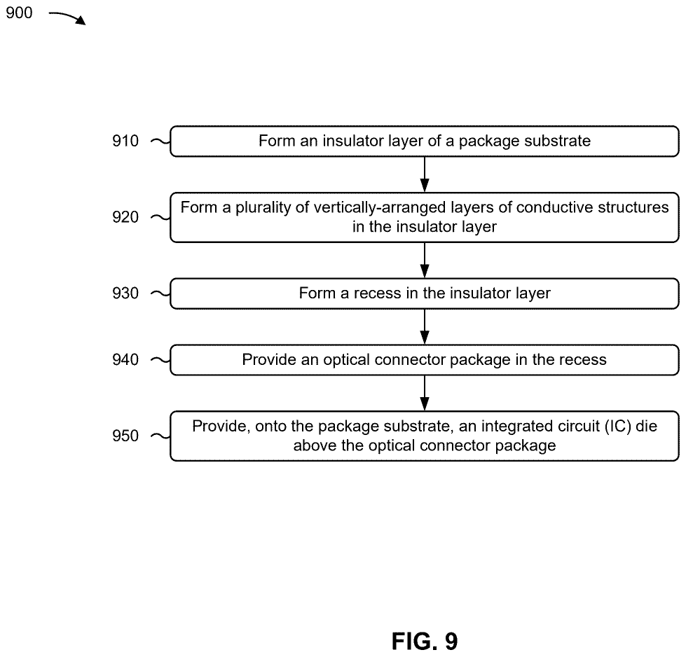

FIG. 9 is a flowchart of an example process 900 associated with forming a semiconductor device described herein. In some implementations, one or more process blocks of FIG. 9 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 9, process 900 may include forming an insulator layer of a package substrate (block 910). For example, one or more semiconductor processing tools may be used to form an insulator layer (e.g., an insulator layer 118) of a package substrate (e.g., a package substrate 104), as described herein.

As further shown in FIG. 9, process 900 may include forming a plurality of vertically-arranged layers of conductive structures in the insulator layer (block 920). For example, one or more semiconductor processing tools may be used to form a plurality of vertically-arranged layers of conductive structures (e.g., metallization layers 124, interconnect layers 126) in the insulator layer, as described herein.

As further shown in FIG. 9, process 900 may include forming a recess in the insulator layer (block 930). For example, one or more semiconductor processing tools may be used to form a recess (e.g., a recess 204) in the insulator layer, as described herein.

As further shown in FIG. 9, process 900 may include providing an optical connector package in the recess (block 940). For example, one or more semiconductor processing tools may be used to provide an optical connector package (e.g., an optical connector package 134) in the recess, as described herein. In some implementations, the optical connector package includes a dielectric structure (e.g., a dielectric structure 136) and an optical fiber (e.g., an optical fiber 138) in the dielectric structure.

As further shown in FIG. 9, process 900 may include providing, onto the package substrate, an IC die above the optical connector package (block 950). For example, one or more semiconductor processing tools may be used to provide, onto the package substrate, an IC die (e.g., an IC die 110) above the optical connector package, as described herein.

Process 900 may include additional implementations, such as any single implementation or any combination of implementations described below and/or in connection with one or more other processes described elsewhere herein.

In a first implementation, providing the IC die above the optical connector package comprises providing the IC die such that a grating coupler (e.g., a grating coupler 132), included in the IC die, is positioned above the optical fiber of the optical connector package.

In a second implementation, alone or in combination with the first implementation, providing the IC die above the optical connector package comprises providing the IC die such that the grating coupler is positioned above an end (e.g., an end 140) of the optical fiber that is facing a top of the package substrate.

In a third implementation, alone or in combination with one or more of the first and second implementations, process 900 includes attaching the package substrate to a device substrate (e.g., a device substrate 504) such that the optical fiber is coupled to another optical connector package (e.g., optical connector package 510) in the device substrate.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

In this way, a device package includes a package substrate, and an optical connector package may be included in the package substrate. The optical connector package may include an optical fiber embedded in the optical connector package, and the optical fiber may be oriented to optically couple optical signals to a grating coupler included in an IC die on the package substrate. The optical fiber may be arranged to receive the optical signals from the side of the package substrate, the top of the package substrate, and/or from portion of the package substrate.

As described in greater detail herein, some implementations described herein include a device package. The device package includes a package substrate and an optical connector package in the package substrate. The optical connector package includes a dielectric structure and an optical fiber in the dielectric structure. The device package further includes an IC die attached to the package substrate, where an optical grating coupler vertically adjacent to an end of the optical fiber.

As described in greater detail herein, some implementations described herein include an electronic device. The electronic device includes a device substrate and a device package attached to the device substrate. The device substrate includes a first optical connector package that includes a first dielectric structure and a first segment of an optical fiber in the first dielectric structure, The device package includes a package substrate and a second optical connector package in the package substrate. The second optical connector package includes a second dielectric structure and a second segment of the optical fiber in the second dielectric structure. The device package further includes an IC die attached to the package substrate. The IC die includes an optical grating coupler vertically adjacent to the second segment of the optical fiber.

As described in greater detail herein, some implementations described herein include a method. The method includes forming an insulator layer of a package substrate. The method includes forming a plurality of vertically-arranged layers of conductive structures in the insulator layer. The method includes forming a recess in the insulator layer. The method includes providing an optical connector package in the recess, where the optical connector package includes a dielectric structure and an optical fiber in the dielectric structure. The method includes providing, onto the package substrate, an IC die above the optical connector package.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device package, comprising:
a package substrate;
an optical connector package, in the package substrate, comprising:
a dielectric structure; and
optical fiber in the dielectric structure; and
an integrated circuit (IC) die attached to the package substrate,
wherein the IC die comprises:
a grating coupler adjacent to an end of the optical fiber.

2. The device package of claim 1, wherein the end of the optical fiber is facing a top of the package substrate.

3. The device package of claim 2, wherein the end of the optical fiber is a first end of the optical fiber; and
wherein a second end of the optical fiber opposing the first end is facing a side of the package substrate.

4. The device package of claim 2, wherein the optical fiber is a first optical fiber;
wherein the optical connector package comprises a second optical fiber in the dielectric structure;
wherein a first end of the second optical fiber is facing the top of the package substrate;
wherein a second end of the first optical fiber opposing the first end of the first optical fiber is facing a first side of the package substrate; and
wherein a second end of the second optical fiber opposing the first end of the second optical fiber is facing a second side of the package substrate that is different from the first side.

5. The device package of claim 4, wherein the first side and the second side are adjacent sides of the package substrate.

6. The device package of claim 4, wherein the first side and the second side are opposing sides of the package substrate.

7. The device package of claim 2, wherein the end of the optical fiber is a first end of the optical fiber; and
wherein a second end of the optical fiber opposing the first end is facing the top of the package substrate.

8. The device package of claim 2, wherein the end of the optical fiber is a first end of the optical fiber; and
wherein a second end of the optical fiber opposing the first end is facing a bottom of the package substrate.

9. An electronic device, comprising:
a device substrate, comprising:
a first optical connector package, comprising:
a first dielectric structure; and
a first segment of an optical fiber in the first dielectric structure; and
a device package attached to the device substrate, comprising:
a package substrate;
a second optical connector package, in the package substrate, comprising:
a second dielectric structure; and
a second segment of the optical fiber in the second dielectric structure; and
an integrated circuit (IC) die attached to the package substrate,
wherein the IC die comprises:
a grating coupler adjacent to the second segment of the optical fiber.

10. The electronic device of claim 9, wherein the first segment of the optical fiber and the second segment of the optical fiber are coupled together between the first optical connector package and the second optical connector package.

11. The electronic device of claim 9, wherein a first end of the optical fiber in the first optical connector package is facing a side of the device substrate; and
wherein a second end of the optical fiber in the second optical connector package is facing the grating coupler.

12. The electronic device of claim 9, wherein a first end of the optical fiber in the first optical connector package is facing a first direction; and
wherein a second end of the optical fiber in the second optical connector package is facing a second direction that is approximately perpendicular to the first direction.

13. The electronic device of claim 9, wherein the optical fiber is a first optical fiber in the electronic device; and
wherein the second optical connector package comprises:
a second optical fiber in the second dielectric structure.

14. The electronic device of claim 13, wherein a first end of the second optical fiber is facing another grating coupler in the IC die; and
wherein a second end of the second optical fiber is facing a side of the package substrate.

15. The electronic device of claim 14, wherein a first end of the first optical fiber is facing the grating coupler; and
wherein a second end of the first optical fiber is facing a top of the device substrate.

16. The electronic device of claim 13, wherein a first end of the second optical fiber is facing another grating coupler in the IC die;
wherein a second end of the second optical fiber is facing a top of the package substrate;
wherein a first end of the first optical fiber is facing the grating coupler; and
wherein a second end of the first optical fiber is facing a top of the device substrate.

17. A method, comprising:
forming an insulator layer of a package substrate;
forming a plurality of vertically-arranged layers of conductive structures in the insulator layer;
forming a recess in the insulator layer;
providing an optical connector package in the recess,
wherein the optical connector package comprises:
a dielectric structure; and
an optical fiber in the dielectric structure; and
providing, onto the package substrate, an integrated circuit (IC) die above the optical connector package.

18. The method of claim 17, wherein providing the IC die above the optical connector package comprises:
providing the IC die such that a grating coupler, included in the IC die, is positioned above the optical fiber of the optical connector package.

19. The method of claim 18, wherein providing the IC die above the optical connector package comprises:
providing the IC die such that the grating coupler is positioned above an end of the optical fiber that is facing a top of the package substrate.

20. The method of claim 19, further comprising:
attaching the package substrate to a device substrate such that the optical fiber is coupled to another optical connector package in the device substrate.
